(19) United States
(12) Patent Application Publication
(10) Pub. No.: US 2011/0282804 A1
(43) Pub. Date: Nov. 17, 2011

(54) System and Method for Market Analysis and Forecast Utilizing At Least One of Securities Records Assessment and Distribution-Free Estimation

(76) Inventor: Michael Shutt, Ewing, NJ (US)

(21) Appl. No.: 13/106,817

(22) Filed: May 12, 2011

Related U.S. Application Data
(60) Provisional application No. 61/334,074, filed on May 12, 2010.

(51) Int. Cl. G06Q 40/00

(52) U.S. Cl. 705/36 R

(57) ABSTRACT

The inventive system and method, preferably implemented in one or more data processing systems, provides various novel techniques for stock market analysis and forecast utilizing at least one technique selected from a group comprising: securities records assessment and distribution-free estimation, to analyze and forecast both long-term trends in various market situations as well as local, short-lived, stock fluctuations. Advantageously, the inventive system and method are capable of taking into account entire groups of stocks, which is particularly advantageous in the cases where individual stocks influence one another.

### CROSS REFERENCE TO RELATED APPLICATIONS

The present patent application claims priority from the commonly assigned co-pending U.S. provisional patent application 61/334,074 entitled “System and Method for Market Analysis and Forecast Utilizing At Least One of Securities Records Assessment and Distribution-Free Estimation”, filed May 12, 2010.

### BACKGROUND OF THE INVENTION

The task of stock market prediction is similar to many other tasks in which one has to forecast some quantity or a group of quantities; however, the challenge in this case is especially difficult, because it involves a great variety of different factors, both random and deterministic. Still, numerous attempts have been made in the past, and are undoubtedly going to be continued in the future, to work out something that may help in the market game. Most such attempts were essentially aimed at establishing and then utilizing various internal and external relationships that exist on the market, describing their joint effect with the aid of some analytical scheme, such as a system of equations, and forecasting the market's future state as a solution to that system.

Unfortunately, these efforts were not very successful, because the relationships are too complex and too unpredictable, and too many essential factors are left out of consideration. Scientists specializing in estimation theory are well aware that incorrect on unreliable information fed to the input of an estimator may produce much greater losses than no information at all or information that corresponds to an average or neutral case. This is why many researchers, having tried a multitude of different models, came to the conclusion that the Gaussian model is still the best for describing the outside world. At best, considering that all prices are strictly positive, they introduced the lognormal distribution, which sometimes does work to a certain extent—depending on the degree to which the current market situation corresponds to some probable course of evolution.

### BRIEF DESCRIPTION OF THE DRAWINGS

In the drawings, wherein like reference characters denote corresponding or similar elements throughout the various figures:

FIG. 1 shows a schematic diagram of an exemplary Quasi-Image Formation graph;

FIG. 2 shows a schematic diagram of an exemplary Observed Segment Z graph;

FIG. 3 shows a schematic diagram of an exemplary Most Likely Prototypes Set graph;

FIG. 4 shows a schematic diagram of an exemplary Current Stock Forecast graph; and

FIG. 5 shows a schematic diagram of an exemplary Most Likely Prototypes Set graph.

### SUMMARY OF THE INVENTION AND DETAILED DESCRIPTION OF THE PREFERRED EMBODIMENTS

### The Stock Market State Analysis and Forecast

### The Methodology of Quasi Random Walk Extrapolations

Advantageously, the system and method of the present invention provide a completely different and superior approach to previously known attempts at stock market prediction. If we cannot establish the mutual influences between the numerous stochastic and deterministic factors and thus predict the results of their joint action, we could try to learn from what happened in the past. In the framework of this approach, it is irrelevant to ask why has a particular market situation occurred: instead, we just find as many similar situations as possible in the past and remember how each of them evolved later. Such information is readily available in the form of stock records. We only have to learn how to extract the required data over a reasonable historical retrospective. Thus, rather than looking for the causes of the present situation, we look for its analogs in the history of the stock or set of stocks in question. Then we only have to see how did the situation evolve in the past, and decide whether we believe that it is going to evolve similarly now.

In this approach we are faced with three distinct tasks:
1. We must be able to correctly record what goes on in the market. This means that we have to solve a feature selection problem.
2. Having recorded the current market state over a certain period, we must be able to adequately identify this state with the most similar historical prototypes, i.e., to construct an optimal pattern recognition method.
3. Finally, the data extracted from the similar stock records must be adequately processed in order to produce useful predictions.

The inventive system and method are advantageously able to able to handle each of the above tasks for even general cases, introducing virtually no restrictions, thus providing a novel market forecast technique that allows determination of answers to at least the following questions, such as:
For a given credibility level, in what range will a given stock be tomorrow, in two days, after a given number of days?
With what credibility will a given stock be in a given price range after a given number of days?
What is the risk (between zero and one) of accepting such a forecast?
At what moment should market operations be carried out in order that the risk remains below a specified level?
At what moment should market operations be carried out in order that the range containing the expected stock value remains smaller than a specified width?
What is the expected risk if the gamble is performed according to a given criterion, such as: smallest loss; highest gain; least mean losses over a given collection of stocks?
When is it expedient to buy a given stock for given decision-making criteria (for instance, the customer wants to identify a stock that will bring a profit of at least a specified amount owing to its rise)?
When is it expedient to sell a given stock?
What is the situation that one should wait for in order to obtain the greatest gain?
Should one expect any cataclysms with the current market situation? If yes, what particular types and with what tendencies?

The inventive system and method, preferably implemented in one or more data processing systems, therefore provides various novel techniques for handling both long-term trends in various market situations as well as local, short-lived, stock fluctuations. It also allows whole stock groups to be taken into account, especially those where individual stocks influence each other.

### Problem Formulation

Consider the problem of predicting a market. A market is a collection of stocks. Then predicting a market means predicting the stock values. Predictions can be constructed for (i) all stocks; (ii) several stocks; (iii) a single stock. We introduce the following assumptions:
1. The realized instant stock value depends on many factors, both stochastic and deterministic. Without claiming to be rigorous, we will call them quasi-random quantities. With certain precautions, these values can be regarded as purely random.
2. The joint action of all factors generates continuous random stock values, each of which possesses a c.d.f.
3. Predictions are constructed based on data on the previous states of the market, from the moment of prediction and back along the time scale. That is, for stock S and prediction time tₒ, corresponding to the (n+1)-st, not yet realized, value of S, we have

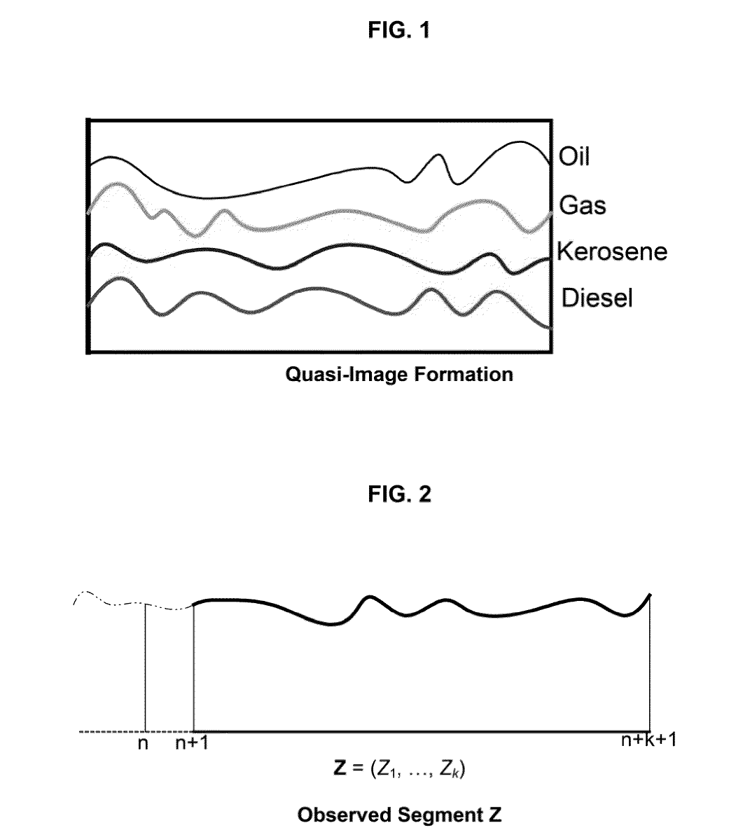

S=(S₁, . . . ,Sₙ).
i.e. n is the stock record length. The entire market is determined by the set of stocks S.
4. Obviously, different stocks, just like the dynamics of other economic indices, influence each other in different degrees. For instance, the price of oil affects the prices of oil products, the price of diamond in Europe depends on the diamond production volumes in South Africa, etc. The degree of this mutual influence (correlation, or regression of certain quantities to others) is a subject of preliminary investigation, which can be based both on experimental data and on expert estimates.
5. In general, the stock value is a one-dimensional variable. However, by assuming the existence of mutual influence, we suppose different stocks to behave in a somewhat correlated, or matching, manner. Then we can construct certain two-dimensional <<quasi-images>>, where each row represents an interval of observations over a single stock, all such intervals corresponding to the same time span. In other words, a quasi-image is an array whose rows are the values of a given stock at different moments, and each column is the set of all stock values at a given moment (see FIG. 1). These arrays can be square or rectangular, depending on the number of stocks included and the observation period.

At this point it would be helpful to introduce certain definitions:
An instant state (IS) of a market is the stock value at a fixed moment.
A historical prototype (HP), or realized segment G (depending on the context), is any subset (subvector) from S of length k, provided that k<n. For k=n, G=S.
   Suppose that, having a history up to the moment t₀, which corresponds to the stock sample n, market observations begin at point (n+1). An observation interval of a given duration—for instance, up to the point (n+k)—will be called a control period (CP).
An observed segment (OS) is a recorded sequence of stock values from the start of observations to the end of the control period. We want to construct an efficient estimate of the event

Sₙ₊ₖ₊ᵢ<S′,i=1,2, . . . ,M. (1)
It is desirable for this estimate to be unbiased, consistent, regular, the best with regard to some reasonable criteria, and stable. It is obvious that an estimate of the most practically interesting event

S″<Sₙ₊ₖ₊ᵢ<S′ (2)
will probably be just a linear combination of estimates (1).

### Nearest Neighbor (or Most Likely Prototype) Principle in Market Analysis

Because the evolution of stocks occurs under the influence of many different factors, of which few can be adequately described by analytical means, and many others may remain unknown, it is impossible to construct a reasonably complete “microscopic” model of the whole process.

Therefore we adopt a phenomenological approach, which relies on the basic assumption that similar consequences are created by similar reasons. More specifically, we assume the following hypothesis to be true:

### Hypothesis I

If a set of influences in the past has led to given realized values of a historical prototype (or segment), and if the current dynamics of an observed segment is similar to that of its historical prototype (according to a selected similarity criterion), then the set of influences existing in the control period is also similar to its historical analog, and will most probably lead to a similar evolution of the observed segment.

We also adopt the following assumption:

### Hypothesis II (Optional)

Predictions are most efficient (more precisely, the gain from a correct prediction is the greatest) in a period of abrupt changes in the market dynamics, with high variations in the stock values over short times.

If we learn to predict such unexpected strong variations, this should yield the greatest effect for the gambler. On the other hand, such periods, which contain sharp changes in the observed variables, are the most unique in shape, easier to recognize, and less prone to be confused. We will say that such intervals, as well as the quasi-images composed for them, are the most informative, and the physical quantity that specifies the degree of their uniqueness will be called the informativity of a given observation. Its formal definition and rules of calculation will be described later in this document.

### General Approach Structure

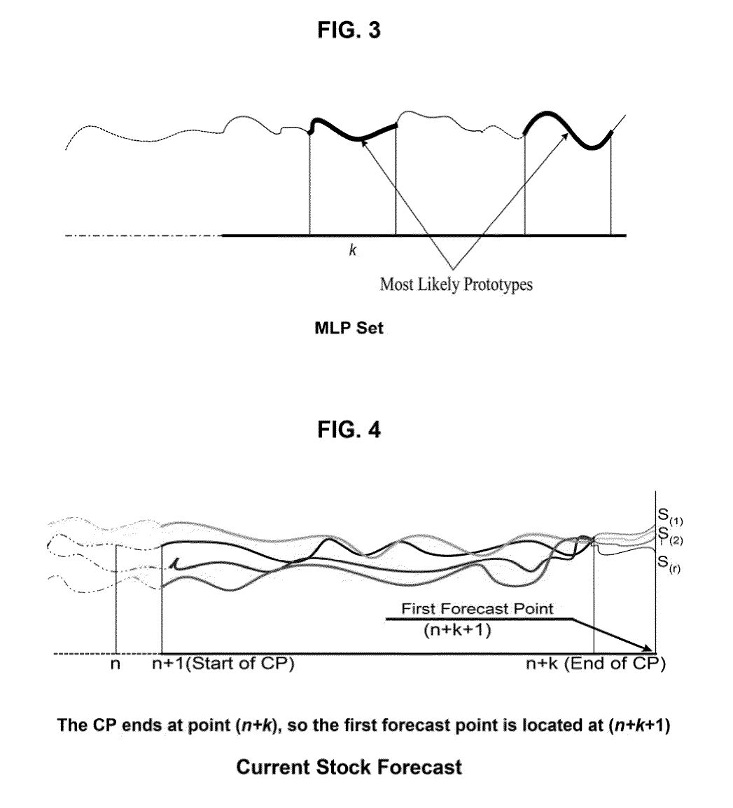

Based on Hypothesis I, the overall task can be broken down into three basic procedures:
1. Stock observation and observed segment formation. Some preliminary processing can be executed here, such as smoothing, trend removal, etc.
2. Historical identification of the OS against the total HP set. A specific pattern recognition algorithm, depending on the actual distribution of the observations, has to be developed for optimal data processing. The identification produces a queue of the most similar segments from the past (the Most Likely Prototypes, or MLPs)—See FIG. 3, for example.
3. Constructing a forecast based on the MLP set.

### Some Useful References

For easier understanding, let us recall some well-known concepts from nonparametric estimation theory. Consider a sample {X} from a general population U, which is strictly positive and has a continuous distribution:

X₁, . . . ,Xᵢ, . . . ,Xₙ (3)

The set of elements of this sample, arranged in nondecreasing order (keeping in mind than no two elements can coincide in a sample from a continuous distribution, we use the sign of strict inequality), is called the set of order statistics:

0<Xᵢ<Xᵢ₊₁< . . . <∞ for all i=1, . . . ,n−1 (4)

and denoted as

X₍₁₎, . . . ,X₍ᵢ₎, . . . ,X₍ₙ₎. (5)

The elements of the order statistics, regardless of the distribution in the original general population U, obey the n-dimensional Dirichlet distribution

$$f ( {x}_{1} , … , {x}_{n} ) = \frac{Γ ( {v}_{1} + … + {v}_{n + 1} )}{Γ ( {v}_{1} ) … Γ ( {v}_{n + 1} )} {x}_{1}^{{v}_{1} - 1} … {{x}_{n}^{{v}_{n} - 1} ( 1 - {x}_{1} - … - {x}_{n} )}^{{v}_{n + 1} - 1} , \qquad ( 6 )$$

where all ν₁ are positive and

$${\sum }_{i = 1}^{n} {x}_{i} \leq 1.$$

This distribution is also denoted D*(ν₁, . . . , νₙ; νₙ₊₁).

Thus, for any given value X we can find the probability of its falling into a specified interval in (5). It suffices to integrate the distribution (6) between appropriate limits; for instance, the probability of falling into the interval between order statistics X₍ₖ₎ and X₍ₖ₊ⱼ₎ is the integral of (6) from X₍ₖ₎ to X₍ₖ₊ⱼ₎.

### Nonparametric Approach to Stock Prediction

For the task at hand, this means that, having a set of observations for a stock and having constructed the order statistics for this set, we can find the probability that the next (expected) value will lie in a specified interval. But this set of observations must be chosen appropriately, in order that the produced estimates be of practical use. Our proposed approach is based on analyzing historical prototypes (“nearest neighbors”), regarded as natural data sources for stock dynamics estimation.

Let us generalize the concept of nonparametric estimation for the case of vector data. This is necessary because in the task at hand, both the observed segment and its historical prototypes are essentially vector variables, since the most important features are the dynamics of time variations and the similarity of different segments viewed as value sequences. Thus, suppose that stock observation during the control period yields a vector Z, as shown in FIG. 2 hereto (hereinafter also referred to as “observation (7)”) Suppose that a number of HPs was found for the observed Z by applying an identification algorithm A:

S₁, . . . ,Sᵣ (8)

The HPs have the same length as Z. All the HPs in (8) were selected based on the values of a response function (RF) produced by algorithm A:

A(Z,S_{q})q=1, . . . ,r. (9)

The RF value (9), a scalar function of vector arguments, defines a measure of similarity between the observation (7) and each tested HP (8). We retain for further analysis a number of “nearest neighbors”, that is, those HPs for which the RF values are the greatest (or exceed a predetermined value, in which case their number r may vary between tests). Let us regard all HPs, or vectors S_{q}, as points in a continuous vector space Ωₛ, and the function (9) as a metric in this space. Then, similarly to (3) and (4), we may order the set of HP vectors (8) in accordance with the values of (9), thus defining a set of vector order statistics:

S₍₁₎, . . . ,S₍ᵣ₎. (10)

arranged by nondecreasing RF values. A set of order statistics constructed in this manner has an important feature: the order of its elements depends on an external observation Z, i.e., a vector whose values are not members of the vector sample (8) itself (in contrast with the case of a scalar sample (3)). With changing values of Z, the sequence of elements in the set of order statistics (10) will change, i.e., its intervals and, accordingly, the values of selected HPs will “adapt” to the current stock variations. This allows us to build “dynamic” (in a sense) nonparametric estimates for the predicted quantity. In the set of order statistics, let us denote

uₖ=F(x₍ₖ_{₁}₎), (11)

where F is the cumulative distribution function of the original distribution.

These variables obey the Dirichlet distribution D*(1, . . . , 1; 1). Let us now consider elements x₍ₖ_{₁}₎ and x₍ₖ_{₁}₊ₖ_{₂}₎, and denote

u=F(x₍ₖ_{₁}₎),ν=F(x₍ₖ_{₁}₊ₖ_{₂}₎). (12)

These two variables have the distribution D*(k₁,k₂; n−k₁−k₂+1). Therefore it can be shown that for the p-th quantile xₚ (defined by the formula F(x₍ₚ₎)=p) holds

$$\begin{matrix}P ( {x}_{( {k}_{1} )} < {\underline{x}}_{p} < {x}_{( {k}_{1} + {k}_{2} )} ) = G \{ {I}_{p} ( {k}_{1} , n - {k}_{1} + 1 ) , {I}_{p} ( {k}_{1} + {k}_{2} , n - {k}_{1} - {k}_{2} + 1 ) \} , \\ where & ( 13 ) \\ {I}_{p} ( m , n ) = \frac{Γ ( m + n )}{Γ ( m ) Γ ( n )} {\int }_{0}^{p} {{x}^{m - 1} ( 1 - x )}^{n - 1} d x & ( 14 )\end{matrix}$$

is the incomplete normalized beta function.

Formula (13) is a key issue. Thus, the probability P{S₍ₖ_{₁}₎<S<S₍ₖ_{₁}₊ₖ_{₂}₎} can be found for the set of order statistics (12). This probability for the entire range covered by the set is very close to unity if the sample volume is not small. That is, for k₁=1 and k₁+k₂=r we have

$$P ( {S}_{( 1 )} < {\underline{S}}_{p} < {S}_{( r )} ) = 1 - {p}^{r} - {( 1 - p )}^{r} , \qquad ( 13 a )$$

which tends to 1 for all p<1 and sufficiently large r.

Note that the probability (13) is independent of the actual distribution of S and allows us to obtain probabilistic predictions in all cases, even if S is a discrete quantity. That is, for any given interval S₍ₖ₎< . . . <S₍ₖ₊ⱼ₎ we have the probability that the value of S recorded at the moment (n+k+1) will lie in this interval (see FIG. 4). If the interval is reduced, the probability will decrease; if the interval is extended, say, to span the full range of [S₍₁₎), S₍ᵣ₎], the probability will be close to unity.

However, an answer will always exist. For instance, suppose that the gambler expects Microsoft stocks to remain between $65 and $66. Suppose for simplicity that both these values are within the same interval (S₍₇₎, S₍₈₎), and the two immediately adjoining order statistics S₍₇₎ and S₍₈₎ are $64 and $66.5. Then we use (13) for calculating the probability for the predicted value to fall into the interval (64, 66.5); if the resulting probability is acceptable for the gambler, he uses this estimate; otherwise, we expand the interval, increasing the estimate's credibility but also increasing its ambiguity.

At point (n+k), we still have an actual value of S, for instance, S₀, therefore all MLP curves have to be normalized so that their rightmost ends be equal to this value. In other words, all MLP trajectories must pass through S₀. Let us draw a vertical line at the first forecast point. Then the MLP trajectories form, at the moment of crossing this line, a set of S values, automatically arranged in nondecreasing order. This set produces the order statistics (12), for which the probability values (13) can be defined. The range [S₁, Sᵣ] should be narrow enough in this case and, as it was shown above (13a), the probability (13) will be very high for this interval. In other words, the forecast should be very precise and credible.

### N.B.!∥ Stepwise Procedures

Thus, having observed the stock dynamics on a control interval, we must find previous prototypes (“nearest neighbors”, or MLPs) of the same length, and use their evolution for predicting the current events. The procedure is as follows:
1. For the control period, construct the observed vector segment Z of length k (7).
2. Based on the analysis of stock value distributions, generate an optimal (in a sense) identification algorithm A (9). The method for constructing algorithm A is available.
3. Applying this algorithm to the available historic data, identify a given (but probably variable) number r of MPLs:

R_{q}=A(Z,S_{q}),q=1, . . . ,r.
The types of the algorithm applied can vary in a very broad range. Some well-known algorithms are cited below. However, in the case of stock prediction it is preferable to utilize the various embodiments of the novel methodologies of the present invention.
   Sample previously known algorithms:
   a. Selection of metrics for finding nearest neighbors
      Option: absolute difference of two functions

S=∫|x(t)−y(t)|dt
Suboption: with additional restriction on the maximum difference at any point

S=∫|x(t)−y(t)|dt,|x(t)−y(t)|≦a,∀tεT
Parametric generalization: absolute difference of functions raised to a power

S=∫|x^{k}(t)−y^{k}(t)|^{ν}dt, usually ν=1/k [symbol] ν=1
Another option: weighted by a function that decreases backward in time

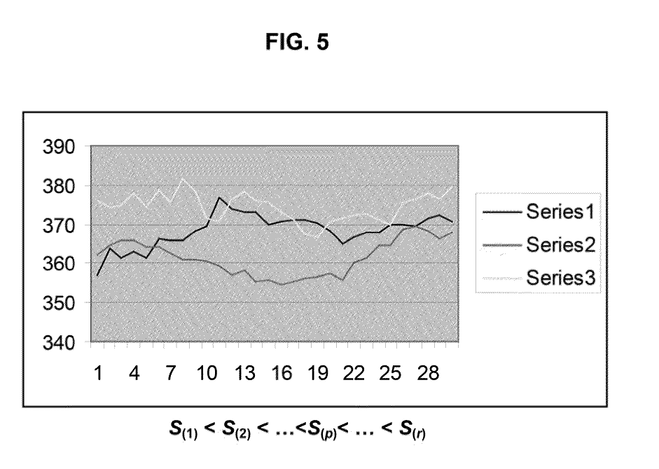

S=∫w(t)|x(t)−y(t)|dt,w(t₁)<w(t₂) np [symbol] t₁<t₂
b. Preprocessing of original functions, including:
   i. Smoothing of fast oscillations
   ii. Trend removal
c. Discontinuity removal before using the selected candidates for prediction (e.g., value equalization at the end point)
d. Methods of building predictions based on the selected candidates
   Option: direct substitution of candidates as the most likely scenarios of further evolution.
e. Candidate weighting (equal or unequal probabilities)
f. Accounting for outside factors, such as:
   i. Generalized indices (Dow Jones etc.)
   ii. Related stocks
   iii. World events
4. Rank the MPL queue (10) according to their similarity with Z. This yields a vector <<set of order statistics>>, for which the role of the absolute value of a scalar sample element is played by the algorithm's response function (RF).
5. Arrange all MPLs on the same time interval. A vertical cross section of the MPL set yields a sample for a fixed time moment (instantaneous values).
6. The instantaneous values are regarded as a usual scalar sample, from which a conventional set of order statistics is constructed—see FIG. 5 by way of example, in which the rightmost cross section is used for producing an estimate at point (n+k+1).
7. After the actual value of S is obtained for point (n+k+1), see FIG. 4, the length of the observed segment is incremented, and the estimation cycle is repeated. (Alternatively, the OS is moved forward, retaining the same length.) The gambler can then decide for himself what risk is acceptable for him. Anyway, he has all numerical estimates, both in terms of probability levels and in terms of predicted ranges—that is, all data required for building his game's strategy and tactics. Such estimates can be enhanced by using the mean risk techniques (see below), which allow one to incorporate various expert and experimental estimates for the functions of expected losses, as well as a priori estimates for stock value variations.
8. The process is terminated upon achieving either the desired probability of event (2), or the desired mean risk value with substituted a posteriori probability (13), or some other criterion, depending on the gambler's preferences.

### Queue Length Selection

The number of <<leaders>> r retained for further analysis can be fixed. Another possible approach is to retain all those leaders whose RF exceeds a specified threshold value. This leads to a variable queue length. In both cases, the leader list may change as new realized stock values are included into the observed segment: some former participants can be replaced by others as they become less similar to the observed market evolution dynamics.

### Practical Usage of the Measurements

From a potential user's standpoint, the very possibility to observe and compare the current stock dynamics with similar situations in the past is useful. Here “similar” is understood in a rather strict sense, according to the criterion of statistical maximum likelihood. Even this tool deserves practical usage. In addition, the proposed MLP family could serve as a basis for the following procedures of forward extrapolation:
1. By the likeliest leader. Because this leader is most similar to the observed segment, it is reasonable to suppose that the situation will further evolve in a similar manner.
2. By the segment produced by “averaging” over the MPL set.
3. By a new leader queue constructed from the MPL family using some kind of smoothing.
4. Any of the above options, where the leader queue is centered with respect to the global or current average.
5. By a stock value range prediction with the associated distribution-free probability estimates.
6. By mean-risk functionals built in accordance with various gamble strategies.

### Mean Risk Estimate for Stock Prediction

When calculating the probability (13), we actually test the hypothesis that our stock value will fall into just that interval. When considering some set of intervals, we are testing a set of hypotheses. At the same time, it is well known that the most general criterion in hypothesis testing is the Bayesian mean risk

$$R ( H \vert Z ) = {\sum }_{v} C ( H \vert {H}_{v} ) P ( Z \vert {H}_{v} ) P ( {H}_{v} ) \qquad ( 15 )$$

where
C(H|H_{ν}) is the loss function, defining the loss upon accepting hypothesis H if the actually valid hypothesis is [symbol]
   P( [symbol] |H_{ν}) is the a posteriori probability that the observation Z originates from hypothesis [symbol]
   P(H_{ν}) is the a priori probability to observe hypothesis

[symbol]

Usually, the a posteriori probability is calculated based on the true distributions, which are available only in the simplest cases. However, the probability (13), obtained for the general distribution-free case, can play this role as well.

The loss function C(^{.}|^{.}) can be used for defining the game strategy. For instance, if a gambler wants to proceed with minimum losses, the function C(^{.}|^{.}) should be a quadratic form, which provides the smallest variation.

### Estimates Employing Quasi-Images

Similar procedures of constructing nonparametric estimates for the stock dynamics are also feasible for the quasi-images mentioned above. In this case, identification is carried out in the set of vector HPs, and order statistics are built from stocks of the same type extracted from the <<leader>> segments produced. Preliminary analysis shows that such complex estimates, based on multiple stocks, must be much more reliable than those obtained in the one-dimensional case.

### Optimal Decision Making

The most general mathematical approach to making the best possible decisions based on a given collection of input data is known as the minimum risk method [1, 2]. For simplicity, we henceforth consider its special case referred to as the maximum likelihood method.

The observed input data is supposed to be a set of random variables, d=(d₁,d₂, . . . ). The distribution of each variable dᵢ depends on the adopted hypothesis H about the actual origin of the input data: f(dᵢ)=f(dᵢ|H). A typical hypothesis might be formulated as “H: This data was produced by the HP #M.” The total distribution of the entire data set is thus also conditional with respect to the adopted (or tested) hypothesis: f(d)=/f(d|H). The maximum likelihood method consists in calculating the conditional probabilities of the observed data set that correspond to all admissible hypotheses, i.e., f(d|Hᵢ), i=0, 1, . . . , M , and then deciding in favor of that hypothesis which yields the highest conditional probability.

The typical pair of hypotheses in a personality verification system is “H₀: This data belongs the HP #M” and “H₁: This data does not belong to the HP #M”. In this case, the system accepts hypothesis H₀ only if its probability greatly exceeds that of its alternative, H₁. To this end, the system establishes a decision threshold with which it compares the ratio of these two probabilities. If this likelihood ratio exceeds the threshold, a positive decision is taken; otherwise, the hypothesis is rejected.

This condition can be written as

$$L ( d ) = \frac{Prob ( {H}_{0} \vert d )}{Prob ( {H}_{1} \vert d )} = \frac{Prob ( {H}_{0} \vert d )}{1 - Prob ( {H}_{0} \vert d )} > T , \qquad ( 16 )$$

where d is the data set and T is the threshold.

### Estimation Reliability as Function of Input Data Amount

The value of T in (16) must be set in accordance with the desired FAR (which stands in the denominator), so T>>1. If a data set d₁ is insufficient for ensuring the validity of condition (16), then we might add another data set d₂. If these two sets are mutually independent, we have

L(d)=L(d₁)L(d₂) (17)

for d=(d₁,d₂). Because each factor on the right is greater than unity, the result is greater than either of them. Thus, by adding new data we can increase the likelihood ratio until (16) becomes valid for any specified.

### Joint Utilization of Dissimilar Data

This part concerns the use of quasi-images for multi-stock forecast evaluation. If two data sets associated with the same collection of hypotheses can be observed simultaneously, the corresponding probabilities multiply:

f(d₁,d₂|H)=f(d₂|H)f(d₂|H).

This formula provides the basis for optimal combination of dissimilar input data into a single quantity for use in decision making, because these distributions may refer to entirely different physical characteristics. Thus, by adding up as much of dissimilar data as needed to satisfy (16), the desired reliability level can be achieved even if no one single feature set can provide this level. This is the basis to form specific quasi-images as a set of one-dimensional “historic patterns” of various origination stocks. Further the two-dimensional image will be considered built at this rule.

### Optimal Choice of Reference Fragments

In general, the degree of usefulness of different stock fragments for their matches is different. Those fragments that contain more unique features, manifest themselves with a higher contrast, and are less prone to various random distortions, will yield more reliable matching results. We call them high-informativity fragments. In mathematical terms, the selected reference fragments must be such that:
(a) they produce independent data sets, so that formula (17) is valid;
(b) each data set has a high discriminative power, i.e., the values of (16) are sufficiently high for each individual data set.

Condition (b) depends on the uniqueness of each feature with respect to a particular situation at the market and on the stability of the input data against various distortions.

Thus, the target search procedure must identify high-informativity fragments for extracting the reference data. The greater the number of such informative fragments, the higher our confidence in the system's reliability.

A theoretically sound and experimentally validated methodology for reference area selection has been developed, which guarantees the selection of the best candidates and allows for accurate prediction of the expected matching error rates. The basics of our approach are briefly outlined below.

Suppose that the task is to match the observed input data d against some reference image (template). A typical hypothesis in this case becomes “H₀: This data was produced by the HP #M and the template corresponds exactly to the indicated portion of d.” All possible hypotheses form the complete hypothesis set.

A positive match will result if a high and narrow response peak is obtained for hypothesis H₀. An experimentally established fact is that if the reference fragments are selected in a reasonable manner, the peripheral response peaks are very low and can be neglected. Then the total hypothesis set is confined to the area that encompasses the main peak location. Therefore the smaller this area, the higher the main peak and the better the system performance. Thus, it is necessary to be able to find such reference fragments that provide the smallest peak pedestal areas.

In the case of a logarithmic classifier, expression (16) becomes

$$J ( d ) = log L ( d ) = log \frac{Prob ( {H}_{0} \vert d )}{Prob ( {H}_{1} \vert d )} . \qquad ( 18 )$$

Then the probability of positive decision for hypothesis H₀ against hypothesis H₁, averaged over the observation ensemble Ω_{d}, is

$$K ( {H}_{0} : {H}_{1} ) = {\int }_{{Ω}_{d}} Prob ( {H}_{0} \vert d ) log \frac{Prob ( {H}_{0} \vert d )}{Prob ( {H}_{1} \vert d )} d d . \qquad ( 19 )$$

For the total hypothesis set,

$$K ( {H}_{0} ) = {\int }_{{Ω}_{d}} K ( {H}_{0} : H ) d H , \qquad ( 20 )$$

where Ω_{H} is the domain of all hypotheses H. (Ω_{H} is an R-dimensional space, where R is the number of elements in each hypothesis.) For digital fragments, integral (19) becomes a finite sum.

It can be shown [4] that the maximum of K is defined by

$$\begin{matrix}{K}^{*} ( {H}_{0} ) = - F ( {H}_{0} ) , \\ where & ( 21 ) \\ F = \{ {F}_{αβ} \} = {E}_{d} \{ - \frac{{\partial }^{2} log L ( {H}_{0} \vert d )}{\partial {τ}_{α} \partial {τ}_{β}} \} & ( 22 )\end{matrix}$$

is the well-known Fisher's information matrix [1], in which differentiation is carried out with respect to the coordinates τ_{α} in the vicinity of the main peak.

However, as pointed out above, all meaningful hypotheses lie around the main peak. Then Ω_{H} is defined by the matching error covariance matrix

C={ρ_{αβ}σ_{α}σ_{β}} (23)
and specifies the integration area as an ellipse whose semiaxes are equal to the principal elements of matrix (20).

The covariance matrix (8) obeys the inequality

det C≧det F, (25)

The equality in (10) is achieved for the optimal matching algorithm, which is preferably the algorithm used in accordance with the present invention. Then the matrix elements can be directly calculated by formula (22), into which we must substitute the correct expression for the particular algorithm. Thus, these magnitudes depend on the image quality and the identification technique employed. This means, in turn, that the most informative (see Hypothesis II) and promising OSs can be selected as being suitable for optimal technique performance.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A data processing method for analyzing stock markets and forecasting expected performance thereof, comprising the steps of:
(a) recording predetermined target stock market activity over a predefined period of time;
(b) determine the current market state over said predefined period of time to identify at least one state comprising the greatest amounts of most similar historical prototypes to formulate an optimal pattern recognition protocol;
(c) identify at least one similar stock performance record and extract target data therefrom; and
(d) analyze and process said target data in accordance with said optimal pattern recognition protocol to produce at least one stock market forecast output.
